(19) United States
(12) Patent Application Publication
(10) Pub. No.: US 2009/0088280 A1
(43) Pub. Date: Apr. 2, 2009

(54) VARIABLE DELIVERY GEAR PUMP

(76) Inventor: Kendall Alden Warren, Oshtemo, MI (US)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(21) Appl. No.: 12/240,288

(22) Filed: Sep. 29, 2008

Related U.S. Application Data
(60) Provisional application No. 60/975,952, filed on Sep. 28, 2007.

(51) Int. Cl. F16H 47/04

(52) U.S. Cl. 475/72

(57) ABSTRACT

A variable displacement gear pump device that provides variable flow while retaining the advantages generally associated with gear pumps, and without diverting pressurized fluid back to the pump inlet. In one embodiment, a gear pump includes a first gear and a second gear forming an external pump, the first gear rotatable about a fixed axis and drivingly engaging the second gear, the second gear rotating about its central axis and selectively movable in an epicyclical relationship with the first gear whereby the discharge of the pump is varied.

### RELATED APPLICATIONS

This application claims the benefit of U.S. Provisional Application No. 60/975,952 filed Sep. 28, 2007, which is hereby incorporated herein by reference.

### FIELD OF THE INVENTION

The present invention relates generally to fluid pumps, and more particularly to a variable displacement gear pump.

### BACKGROUND OF THE INVENTION

Conventional gear pumps are used in many applications and come in a wide variety of designs. FIGS. 1 and 2 show the main components of a typical external gear pump 1 in a plan view. The standard features of the prior art external gear pump 1 include: two gears of equal tooth count and face width, a drive gear 3 and a driven gear 5. The drive gear 3 typically utilizes an internal spline to drive the drive gear 3 and the gear mesh of the drive gear 3 and the driven gear 5 drives the driven gear 5. The driven gear 5 thus rotates at the same speed as the drive gear 3. The meshing of the teeth on the two gears causes differential volumes to occur for fluid intake and discharge. As shown, fluid passes from the inlet passageway (left side) into the gear mesh as it opens and then is carried by the tooth space around to the discharge side (right side), where the gear mesh forces the fluid to exit into the pressurized passageway. The gear pump 1 imparts fluid motion in this way to pump the fluid, but does not “create” pressure, which is a characteristic determined by the system.

In general terms, an internal gear pump is similar to the external gear pump 1 in function and in characteristics. Often referred to as an internal crescent pump, the internal gear pump utilizes a feature (e.g., a crescent) to isolate discharge flow from the inlet. FIG. 2 shows an internal spur gear pump 1′ with an external drive gear 3′ and a slightly larger internal driven gear 5′. The driven gear 5′ has a larger number of teeth than the drive gear 3′ in order to fit the drive gear 3′ inside it. The driven gear 5′ rotates in the same rotational direction as the drive gear 3′.

Gear pumps are typically fixed discharge devices that deliver a steady flow of fluid proportional to the drive speed of the pump. If the fluid is discharged in excess of the system requirement, the excess fluid must be delivered back to a tank or to the pump inlet, via a bypass valve or the like, at the expense of lost mechanical power.

Attempts have been made at developing a variable delivery gear pump. The appeal of a making a gear pump a variable delivery device is that the gear pump itself is a simple, reliable device, with diverse applications in fuel pumps, lubrication and scavenge pumps, hydraulic pumps and many other applications. Thus, if an equally simple method of making a gear pump a variable displacement device could be developed, the resulting gear pump would be reliable and robust compared to other positive displacement pumps that are variable flow, or to pump systems that require a metering valve and a bypass return circuit.

In at least one prior art variable delivery gear pump design, the discharge flow is diverted back to the pump inlet before reaching the discharge passage. Such device, however, is generally inefficient since the diverted fluid is already pressurized, and thus work has already been done on the fluid. Thus, it is no different than running the discharge flow through a fuel metering unit (FMU) or the like and then diverting flow back to the pump inlet. In such device, the work to pressurize the fluid has occurred and resultant heat must then be removed, usually by a heat exchanger.

### SUMMARY OF THE INVENTION

The present invention provides a variable displacement gear pump device that provides variable flow while retaining the advantages generally associated with gear pumps, and without diverting pressurized fluid back to the pump inlet.

Accordingly, a variable delivery gear pump having a pump outlet for supplying fluid to a load comprises a drive gear, a planet gear engaging the drive gear, the planet gear and the drive gear forming an external gear pump, and a ring gear engaged by the planet gear, the planet gear and the ring gear forming an internal gear pump. The pump may have a plurality of planet gears, each planet gear engaging the drive gear and the ring gear and forming a respective external gear pump and a respective internal gear pump. The planet gears may be mounted on a carrier, and a spacer member may be positioned between respective planet gears. The spacer member can provide a tip seal surface for at least one of the adjacent planet gears, the drive gear, and the ring gear. The ring gear can be selectively rotatabed relative to the sun gear to vary the flow from the gear pump when the drive gear is rotating at fixed speed. A flow control valve for controlling the flow from the internal gear pump to the pump outlet can be provided, wherein rotation of the sun gear in relation to the drive gear is a function of flow volume through the flow controller.

According to another aspect, a gear pump comprises a first gear and a second gear forming an external pump, the first gear rotatable about a fixed axis and drivingly engaging the second gear, the second gear rotating about its central axis and selectively movable in an epicyclical relationship with the first gear at a variable speed and direction whereby the discharge of the pump is varied.

According to another aspect, a variable delivery gear pump having a pump outlet for delivering flow to a load comprises a central drive gear for pumping fluid between a first inlet and a first outlet, at least one intermediate gear drivingly engaged with the central drive gear and supported for rotation about a central axis of the central drive gear for pumping fluid between a second inlet and a second outlet, a ring gear engaged with the at least one intermediate gear, and at least one spacer positioned between the central gear and the ring gear and having sealing surfaces against which gear teeth of the central gear and intermediate gear seal, the spacer together with the central gear and intermediate gear defining flow paths for the flow of fluid between respective inlets and outlets, and the spacer further being supported for rotation about the central axis of the central drive gear with the at least one intermediate gear. The ring gear can be selectively rotatable, in both speed and direction for example, to vary the flow from the outlet of the gear pump while the drive gear is rotating at fixed speed.

The variable delivery gear pump can further comprise a flow controller for controlling flow from the second outlet to the pump outlet, wherein rotation of the ring gear relative to the drive gear is a function of the flow volume of fluid passing through the flow controller. A port plate can include the first and second inlets and outlets for supply and return of fluid to the flow paths.

According to another aspect, a variable delivery gear pump having a pump outlet for delivering flow to a load comprises a central drive gear, a planet gear driven by the central drive gear, the planet gear and the central drive gear forming a first external gear pump for pumping fluid from a first inlet to a first outlet, and a ring gear engaged with the planet gear, the planet gear and the ring gear forming a first internal gear pump for pumping fluid from a second inlet to a second outlet. The discharge from the first external pump is split between the second inlet and the pump outlet, and the first outlet and the second inlet are at a common pressure. The pump can further comprise a flow controller for controlling the flow of fluid from the second outlet to the pump outlet, wherein rotation of the ring gear relative to the drive gear is a function of the flow volume of fluid passing through the flow controller.

A plurality of planet gears, each planet gear engaging the drive gear and the ring gear and forming a respective external gear pump and a respective internal gear pump, can be provided along with a carrier on which the plurality of planet gears are mounted. A spacer member can be positioned between respective planet gears, the spacer member providing a tip seal for at least one of the adjacent planet gears, the drive gear, and the ring gear.

According to another aspect, a gear pump comprises an external gear pump formed by at least two sprockets, and an internal gear pump formed by one of the at least two sprockets and a ring gear, wherein the external gear pump and internal gear pump are positioned within a housing.

Further features of the invention will become apparent from the following detailed description when considered in conjunction with the drawings.

### BRIEF DESCRIPTION OF THE DRAWINGS

FIG. 1 is a schematic illustration of a typical prior art external gear pump;

FIG. 2 is a schematic illustration of a typical prior art internal gear pump;

FIG. 3 is a schematic illustration of an exemplary epicycloid external gear pump in accordance with the invention;

FIG. 4 is a schematic diagram of a flow circuit of an exemplary variable delivery gear pump in accordance with the invention;

FIG. 5 is a graph of the rotational speed of a ring gear versus a carrier for a particular rotational speed of a driven sun gear of a an exemplary variable delivery gear pump in accordance with the invention;

FIG. 6 is an end view of an exemplary variable delivery gear pump in accordance with the invention;

FIG. 7 is a cross-sectional view of the pump of FIG. 6;

FIG. 8(a) is another cross-sectional view of the pump of FIG. 6;

FIG. 8(b) is a front view of a port plate of the pump of FIG. 6;

FIG. 8(c) is a bottom view of the port plate of FIG. 8(b); and

FIG. 9 is a cross-sectional view of an exemplary motor driven pump in accordance the invention.

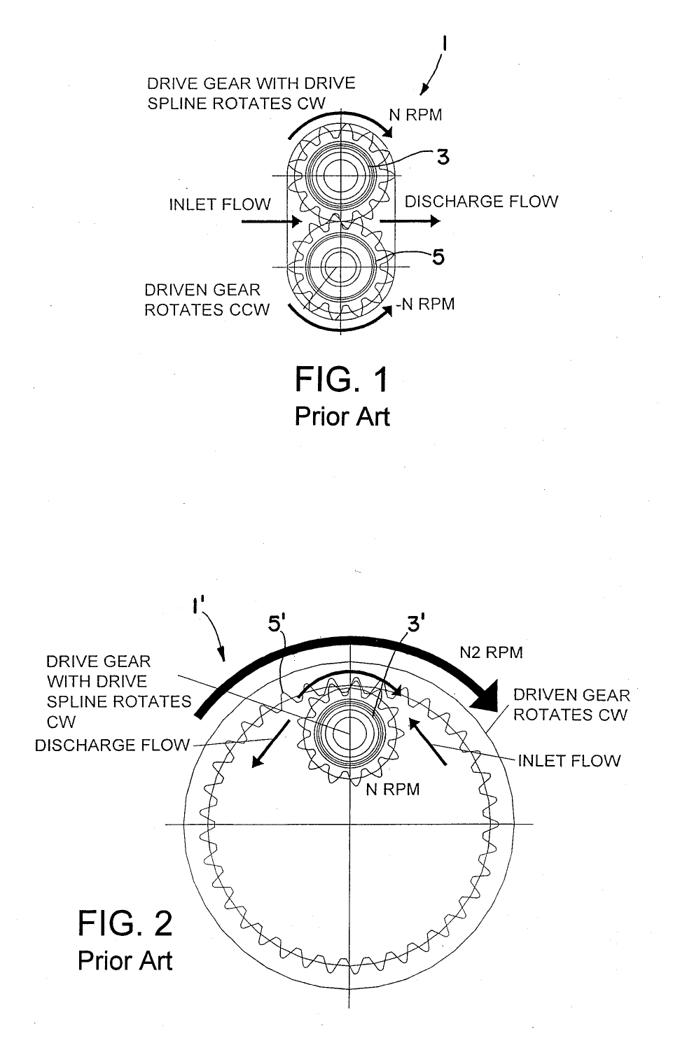

### DETAILED DESCRIPTION

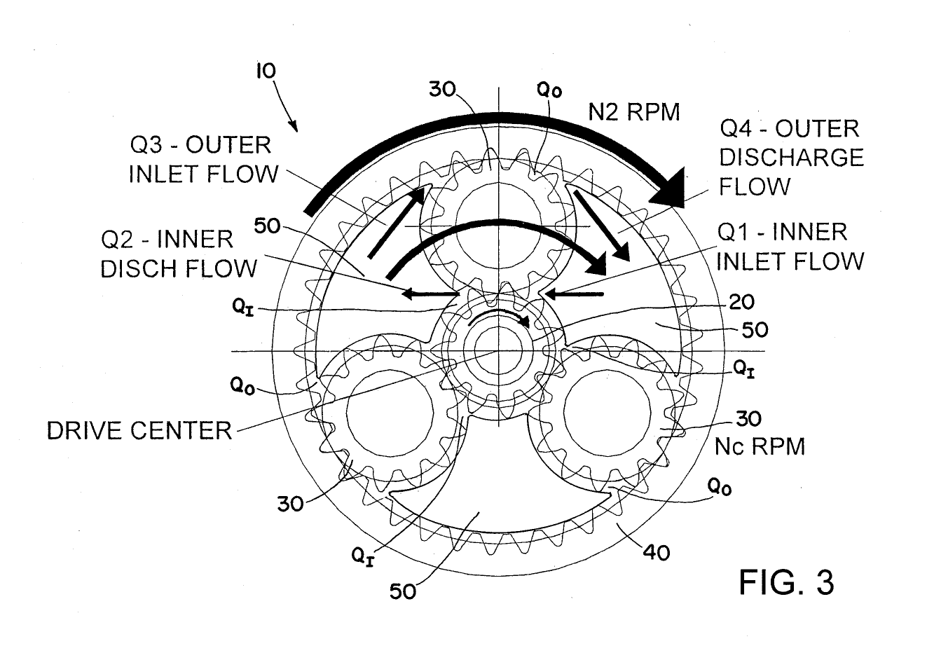

Referring now to FIG. 3, an exemplary variable delivery gear pump 10 is shown that combines the mechanisms of an external gear pump and an internal gear pump into a single pumping mechanism that looks similar to a planetary gearset. Pump 10 includes a central drive gear 20, as referred to as a sun gear, drivingly engaging three idler gears 30, shown herein as three planet gears (sometimes referred to as intermediate gears), which each engage a ring gear 40. The idler gears 30 are supported by a carrier (not shown in FIG. 3) that also rotates. Thus, the idler gears 30 can rotate about their own central axes, and also about the central axis of the drive gear. Between each idler gear 30 is a tip seal spacer 50 against which the teeth of the gears seal in order to pump fluid. The tip seal spacers 50 are also supported by the carrier (not shown in FIG. 3).

The drive gear 20 at the center of the pump is an 11-tooth gear driven by a drive feature such as an internal spline (not shown). Concentric to the drive gear 20 is the outer ring gear 40, which rotates independently of the drive gear 20. The drive gear 20 rotates at input speed Nt. This is analogous to the sun gear speed in an epicyclic gear train.

For each idler gear 30 there are essentially two flow paths to be considered. The first flow path, referred to as the inner flow, is developed at the meshing of each idler gear 30 and the drive gear 20 in the regions labeled Q_{I} in FIG. 3. The second flow path, referred to as the outer flow, is developed at the meshing of the idler gears 30 and the ring gear 40 in the regions labeled Q_{O}. As will be described in more detail below, the inner flow associated with each idler gear is split into two parts with a portion being supplied to the inlet of the outer flow, and a portion being fed to an outlet of the pump for delivery to a load.

In the illustrated embodiment, the three idler (planet) gears 30 provide load balance and result in essentially three pumping mechanisms instead of one. it will be appreciated that fewer or more idler gears 30 can be employed. The following analysis is for one of the three pump “legs”, and will then be multiplied by three for the result.

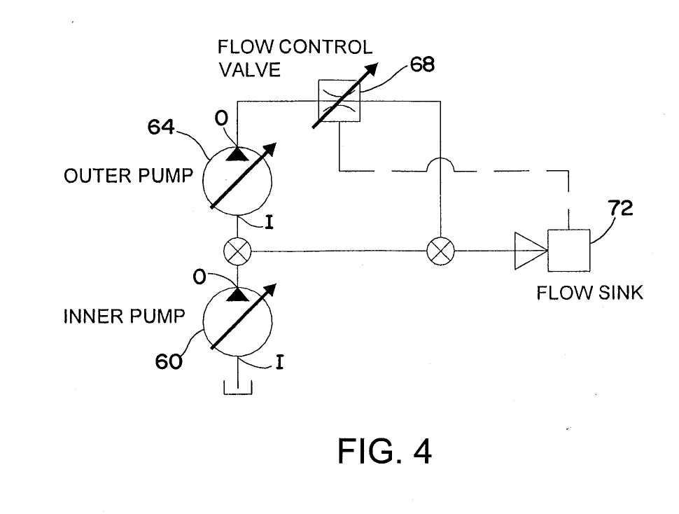

Turning to FIG. 4, a schematic diagram illustrates a hydraulic circuit for the gear pump 10, with the plurality of inner pumps represented by an inner pump 60 and the plurality of outer pumps represented by an outer pump 64. Accordingly, the circuit includes inner pump 60 having an inlet I and an outlet O (e.g., develops the inner flow), outer pump 64 having an inlet I and an outlet O (e.g., develops the outer flow), a flow control valve 68 connected to the outlet of the outer pump 64 for controlling the outer flow, and a flow sink 72. As will be appreciated, the outlet of the inner pump 60 is split, with a portion of the flow going to an inlet of the outer pump, and a portion going to the flow sink.

During operation of the pump, by controlling the amount of flow that flows from the outlet of the outer pump 64 to the flow sink 72, the total pump outflow can be controlled. For example, when the flow control valve 68 is closed (e.g., no flow from the outer pump 64), only fluid from the inner pump is provided to the flow sink 72. In this condition, there is a minimal flow rate for a given pump speed, and the outer pump 64 does not operate to pump fluid any fluid. Instead, all flow is generated by the inner pump 60.

Under such condition, since the outer pump 64 receives fluid only from inner pump 60—the outer pump 64 inlet pressure is the same as inner pump 60 discharge pressure. The outer pump 64 discharge flow is at its discharge (control) pressure into the flow control valve 68. Since all the outer flow is going to the valve 68, the valve controls the flow, which then controls the ring gear speed. Accordingly, ring gear speed is a function of flow through the flow control valve. Therefor, in a low flow condition (e.g., flow control valve is closed), the outer pump 64 has no flow going through it so the ring gear rotates in sync with the sun gear (drive gear). As demand flow goes up, the control valve 68 is opened and the ring rear relative speed to sun gear speed increases.

Accordingly, when the flow control valve is open some of the discharge from the inner pump 60 is fed to the inlet of the outer pump 64. The ring gear thus increases its relative speed to the sun gear (drive gear) thereby resulting in the outer pump 64 delivering more flow to the flow control valve 68. Of course, since some of the flow from the inner pump 60 is diverted to the outer pump 64, the amount of flow from the inner pump 60 to the flow sink 72 at a given pump speed is decreased. Such decrease in flow, however, is offset by the additional flow from the outer pump 64. Thus, by controlling the outer pump 64 discharge via the flow control valve 68, the net displacement of the pump can be controlled. As will be appreciated, the flow control valve could be piloted by the downstream pressure to flow at a set pressure, or actuated electrically, for example.

A numerical example of the pump flow follows. It is assumed for the moment that the carrier or control speed Nc is known. The inner flow from is:

Q1=DP*(N−NC) (1)

where:
DP=Standard pump displacement from calculation of tooth volume, given in in3/revolution
Q1=Controlled pump volumetric flow (in 3/minute)

Supposing that the inner pump discharge flow Q2 is now split into two parts:

Q2=Qd2+Q3 (2)

Qd2=Part of discharge flow from inner pump (primary useful flow)
Q3=Inlet flow to outer pump (outer control flow and secondary useful flow)
Accordingly, the outer flow is now given by (with Nc>N2):

Q3=Q4=DP2*(NC−N2) (3)

Dp2=the displacement calculated for the internal ring gear; and
N2=the internal ring gear speed. It is noted that the flow rate is positive in the direction shown for N2>Nco If Ne is the greater speed, flow reverses.

The flow rate from the outer pump is the controlled flow. It will be seen eventually that the outer flow may itself be split, particularly if a given application has split system circuitry and different flow and pressure requirements that may take advantage of this split. For now, it is assumed that 100% of the outer flow is to be the controlled flow.

Since Q3=Q4 is known and DP2 is the known outer stage displacement, the speed difference (NC−N2) is a controlled speed differential.

Now the kinematic relationship of the epicyclic gear train can be used. The relationship of sun gear speed, carrier speed and ring gear speed in an epicyclic gear train is the well-known formula:

where:

NSun+K*NRing=(K+1)*NCarrier (5)

K=Ratio of ring gear teeth to sun gear teeth=tRing/tSun
tRing=Ring gear number of teeth
tsun=Sun gear number of teeth
NRing=Ring gear speed (=N2)
Nsun=Sun gear speed (=Nt)
NCarrier=Carrier speed (=Nc)

By obtaining the algorithm on the system flow control valve, which regulates outer stage flow, and knowing the characteristics of the primary discharge flow, the flow rate to the system becomes completely determinate.

### EXAMPLE

Let the gear pump 10 be composed of:

tRing=Ring gear number of teeth=37

tSun=Sun gear number of teeth=11

tPlanet=Planet gear number of teeth=(37−11)/2=13

P=Gear pitch=8.4667 (inch units=>Standard module=3 mm)

Nsun=Sun gear speed (=Nt)=6000 rpm

NRing=Ring gear speed (=N2)

NCarrier=Carrier speed (=Nc)

K=Ratio of ring gear teeth to sun gear teeth=NRingINSun=37/11=3.3636

FW=Gear face width=1.25

Inner and outer stationary displacements are first calculated:

Dp1=1.24 in 3/revolution−inner stage displacement determined by geometry

Dp2=4.06 in 3/revolution−outer stage displacement determined by geometry.

If the carrier is stationary, the inner pump is an ordinary gear pump and has a flow rate:

QI=Q2=Dp1*(N1−Nc)=1.24×(6000−0)/231=32.2 gpm

Now a pump output of 0.50 gpm is desired as a low flow condition at “turndown” of engine flow requirement. This total flow must be the inner pump output per the initial assumption that the pump outer flow is not split. The control speed must therefore be:

Nc=6000−(0.50*231/1.24)=5907 rpm

We suppose that the pump discharge flow directly from the inner stage is 0.30 gpm. The controlled flow is therefore (0.50−0.30)=0.20 gpm. Putting these values into the outer stage equation:

=4.06×(5907−Nz)=0.20×231

N2=5896 rpm

The outer ring gear is therefore rotating at 5896 rpm, which was to be expected because of the low flow condition. For this example, the ring gear 40 speed is very close to sun gear 20 speed of 6000 rpm. This was to be expected because, for this low flow condition, pump output flow is considerably less than pump flow capability so the relative speed between sun gear and ring gear is low. If the output flow were brought to zero by closing the flow control valve completely, the ring gear 40 speed would be synchronous with sun gear 20 and relative speed would then be zero rpm.

This foregoing example can be carried a step further by introducing pressure into the example to illustrate how this pump is superior to the standard gear pump.

If a standard external gear pump is run at the above low flow condition and at a discharge pressure of 1200 psi, it is easily seen that the pump is taking in full mechanical power:

HPtheor=(Pump torque)×(speed)=(1.24×1200/21 t)×6000/63025=22.5 horsepower

With a typical mechanical efficiency on this pump of 85%:

HPactual=22.55/0.85=26.5 horsepower

The useful fluid power output is:

HPfluid=(0.50)(1200)/1714=0.35 horsepower

System efficiency (with 100% volumetric efficiency) is therefore 0.35/22.5=1.6%.

In comparison, the inner stage of the exemplary gear pump 10 of the present invention has relative rotation between the sun gear 20 and carrier 32, such that an “apparent pump displacement” results.

DPI−apparent=D p1(1−Nc/N1)=1.24×0.016=0.019 in 3/revolution

Inner stage actual power is therefore:

HPJ=(0.019×1200/21 t)×6000/63025/0.85=0.41 horsepower

The outer stage also has relative rotation between ring and carrier, so the outer ring pump has “apparent displacement” also:

DP2−apparent=D pz(1−Nz/Nd=4.06×0.0018=0.0076 in 3/revolution

Outer stage power is dependent on pressure drop across the flow control valve. For this example, let the pressure drop be 200 psid:

HP2=(0.0076×200/2 n)×5896/(63025×0.85)=0.03 horsepower

This may be checked by simply noting that outer stage actual fluid power is:

HP2-fluid=(0.20)(200)/1714/0.85=0.03 horsepower

Total mechanical power=0.41+0.03=0.44 horsepower=>Efficiency=0.35/0.44=80%.

Accordingly, the efficiency is much improved over the standard gear pump with bypass return. The simple schematic of FIG. 4 illustrates such a system.

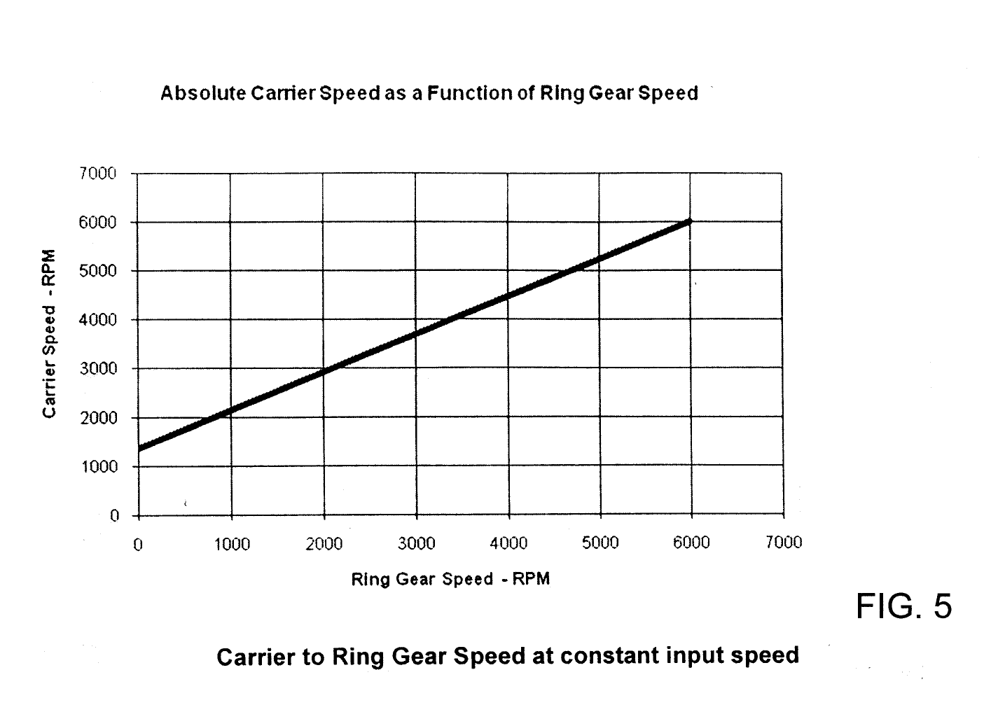

At an inner (input) gear speed of 6000 rpm, the carrier speed is governed by the ring gear speed and determined by the epicyclic gear train equation. The graph at FIG. 5 shows this linear relationship between carrier and ring gear speed. Note from the equation that carrier speed can be made zero by rotating the ring gear at a speed in the opposite direction to that shown in FIG. 4:

NRing(zero carrier speed)=−Nsun/K

In the example, ring gear speed=−1784 rpm for stationary carrier.

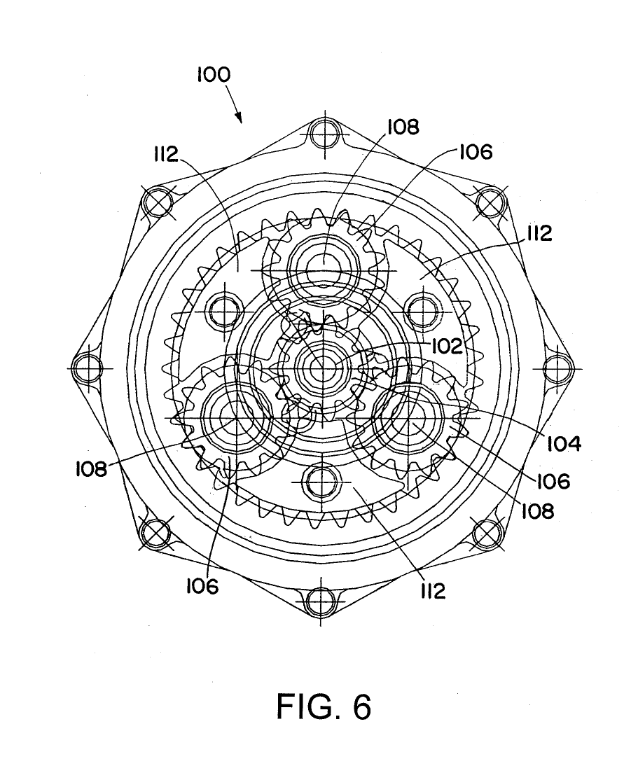

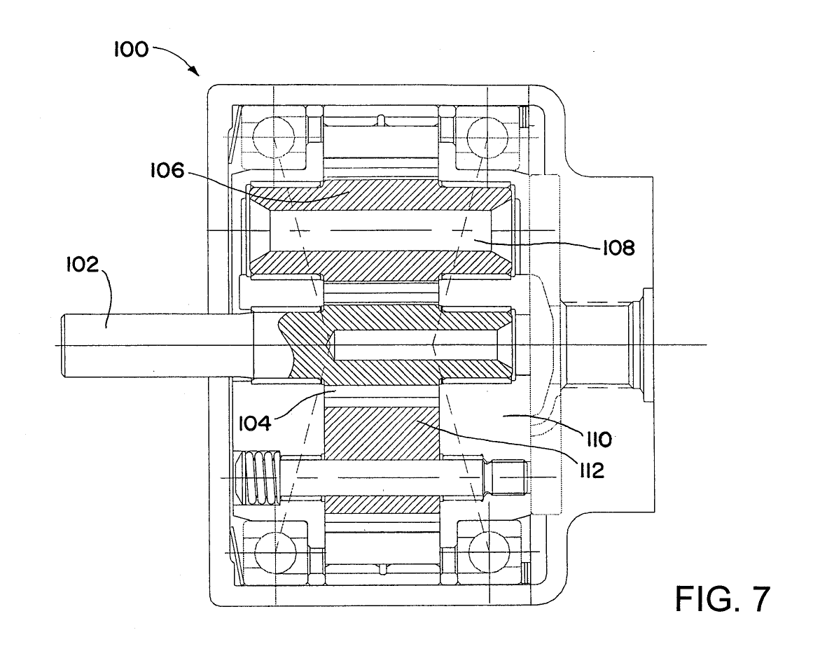

Referring now to FIGS. 6-8(c), and initial to FIGS. 6 and 7, an exemplary pump 100 in accordance with the invention is illustrated. The pump 100 includes an input shaft 102 drivingly connected to a drive gear 104, which in turn is intermeshed with idler gears 106 which are supported on respected arbors 108 housed in a carrier 110. Tip seal spacers 112 provide the tip sealing surfaces on three sides for the gear tips. This is analogous to the housing wall on the inlet side in a standard gear pump, for example. As will be appreciated, tip seal is a feature of gear pumps and a gear tip wipe is usually built into the pump assembly. Thus, the standard gear pump typically has a “final machining” of the gear tip into the housing as a standard procedure in the test and break-in phase of the production pump. Several pump manufacturers have moved away from this by carefully tolerancing the parts so that a very close clearance, e.g., 0.005−0.010 mm (0.0002−0.0004 inch), exists between gear tip and housing, which, without limiting the present invention, will be the approach discussed herein for the variable delivery pump 10.

By holding the tolerance very close, the traditional problem of machining the housing at break-in is avoided. The pump 100 remains clean, with no chips and/or shavings from break-in that could be problematic later. Also, the tip machining wipe imposes additional stresses that can be very hard on the gears and bearings, particularly if the housing is hard or inconsistent in machining strength.

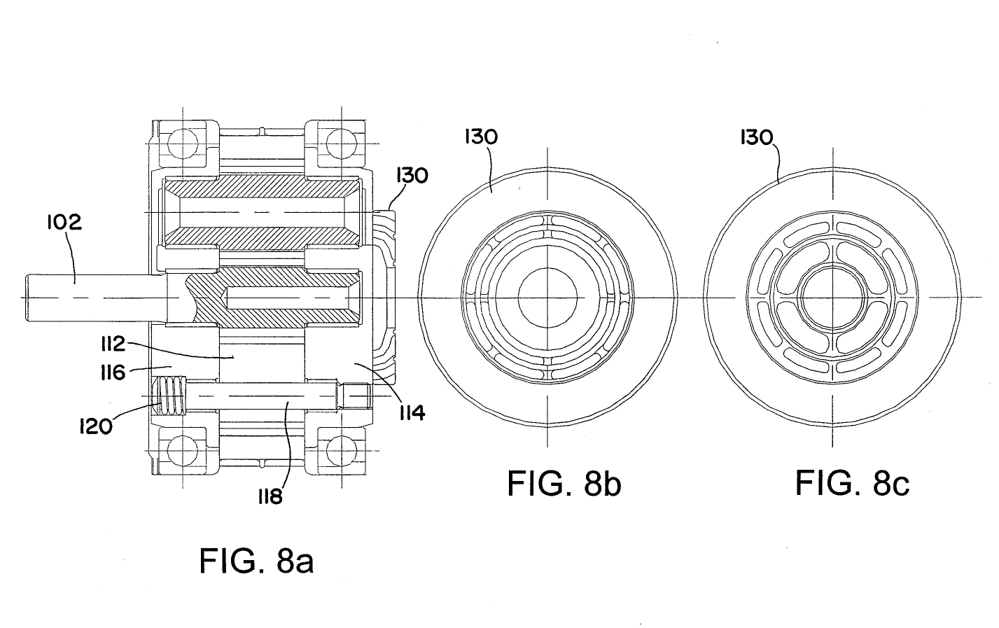

A second function of the seal spacers 112 is illustrated in the pump cross section shown in FIG. 8(a). The spacers 112 are the structural members that provide side sealing at a fixed precision length between carrier end plates 114 and 116. The tip seal spacers 112 are assembled with screws 118 through the end plates 114 and 116 that have stiff springs 120 to load the end plates 114 and 116. In this scheme, the end plates 114 and 116 actually load against the spacers 112, with a fixed clearance for the idler gears 106. This promotes good mechanical efficiency and, because the spacers 112 and gears 106 are all precision width, the volumetric efficiency may be acceptable. Other schemes have been devised to actually pressure load the end plates 114 and 116, or inserts, against the gear sides for better sealing capability, and these are also contemplated as usable with the pump of the present invention.

The variable discharge pump 100 further comprises a port plate 130 that passes the fluid in and out of the inner and outer stages. FIG. 8(a) shows the pump assembly 100 in cross section with the exemplary port plate 130 in place (port cap has been removed) and FIGS. 8(b) and 8(c) show the inner and outer surfaces of the port plate 130, respectively, where it interfaces with the port cap.

The port plate 130 design is analogous to the piston pump port plate, wherein the piston barrel is in axial contact, due to pressure loading, with the plate. The exemplary port plate 130 of the present invention is a generally simpler design because there are no transition zones from inlet to discharge. The port plate 130 simply provides a way to seal the interface where inlet flow, inner stage discharge flow and outer stage control flow pass through into the port cap, where the flow control valve may be located.

The technology of the port plate support is well understood from piston pumps. It can, for example, incorporate Kingsbury-type thrust pads for bearing support of the plate against the rotating carrier. Sealing is by the smooth surfaces between the port slots. It is also contemplated that fluid passageways (not shown) may be incorporated into the tip seal spacers 112.

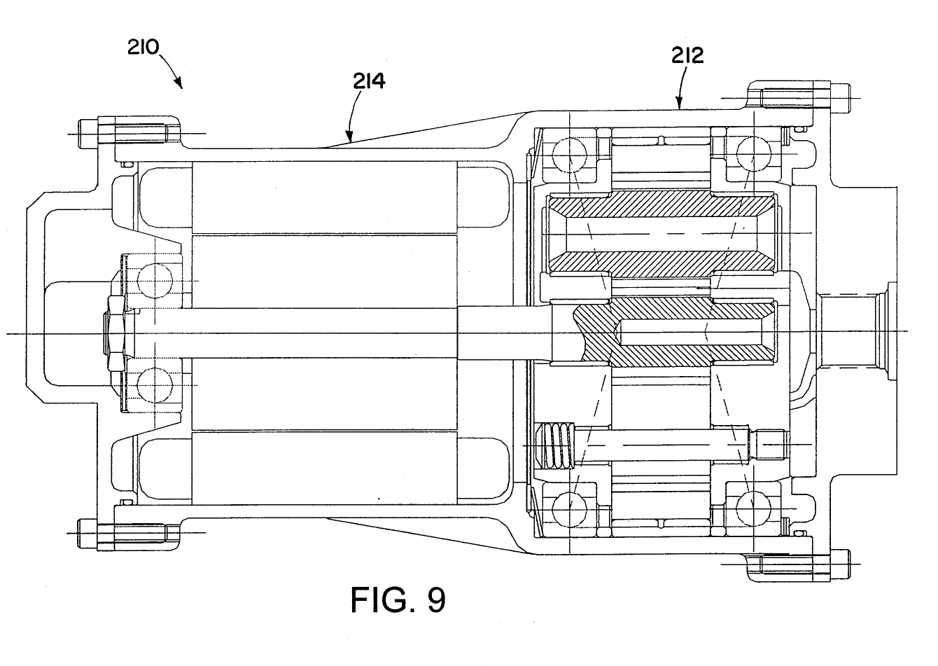

FIG. 9 provides an example a motor driven pump assembly 210 including a variable delivery gear pump 212 in accordance with another embodiment of the present invention. In this embodiment, the exemplary gear pump 212 and a motor assembly 214 are located in a common housing, with the motor 214 configured to drive the gear pump 212. The motor 214 can be a hydraulic or electric motor for example.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A variable delivery gear pump having a pump outlet for supplying fluid to a load comprising:
a drive gear;
a planet gear engaging the drive gear, the planet gear and the drive gear forming an external gear pump; and
a ring gear engaged by the planet gear, the planet gear and the ring gear forming an internal gear pump.

2. The gear pump of claim 1, further comprising a plurality of planet gears, each planet gear engaging the drive gear and the ring gear and forming a respective external gear pump and a respective internal gear pump.

3. The gear pump of claim 2, further comprising a carrier on which the plurality of planet gears are mounted.

4. The gear pump of claim 2, further comprising a spacer member positioned between respective planet gears, the spacer member providing a tip seal for at least one of the adjacent planet gears, the drive gear, and the ring gear.

5. The gear pump of claim 1, wherein the ring gear is selectively rotatable relative to the sun gear to vary the flow from the gear pump when the drive gear is rotating at fixed speed.

6. The gear pump of claim 5, further comprising a flow control valve for controlling the flow from the internal gear pump to the pump outlet, wherein rotation of the sun gear in relation to the drive gear is a function of flow volume through the flow controller.

7. A gear pump comprising a first gear and a second gear forming an external pump, the first gear rotatable about a fixed axis and drivingly engaging the second gear, the second gear rotating about its central axis and selectively movable in an epicyclical relationship with the first gear at a variable speed and direction whereby the discharge of the pump is varied.

8. A variable delivery gear pump having a pump outlet for delivering flow to a load comprising:
a central drive gear for pumping fluid between a first inlet and a first outlet;
at least one intermediate gear drivingly engaged with the central drive gear and supported for rotation about a central axis of the central drive gear for pumping fluid between a second inlet and a second outlet;
a ring gear engaged with the at least one intermediate gear;
at least one spacer positioned between the central gear and the ring gear and having sealing surfaces against which gear teeth of the central gear and intermediate gear seal, the spacer together with the central gear and intermediate gear defining flow paths for the flow of fluid between respective inlets and outlets, and the spacer further being supported for rotation about the central axis of the central drive gear with the at least one intermediate gear;
wherein the ring gear is selectively rotatable in both speed and direction to vary the flow from the outlet of the gear pump while the drive gear is rotating at fixed speed.

9. A variable delivery gear pump as set forth in claim 8, further comprising a flow controller for controlling flow from the second outlet to the pump outlet, wherein rotation of the ring gear relative to the drive gear is a function of the flow volume of fluid passing through the flow controller.

10. A variable delivery gear pump as set forth in claim 8, further comprising a port plate including the first and second inlets and outlets for supply and return of fluid to the flow paths.

11. A variable delivery gear pump having a pump outlet for delivering flow to a load comprising:
a central drive gear;
a planet gear driven by the central drive gear, the planet gear and the central drive gear forming a first external gear pump for pumping fluid from a first inlet to a first outlet; and
a ring gear engaged with the planet gear, the planet gear and the ring gear forming a first internal gear pump for pumping fluid from a second inlet to a second outlet;
wherein the discharge from the first external pump is split between the second inlet and the pump outlet; and
wherein the first outlet and the second inlet are at a common pressure.

12. A variable delivery gear pump as set forth in claim 11, further comprising a flow controller for controlling the flow of fluid from the second outlet to the pump outlet.

13. A variable delivery gear pump as set forth in claim 12, wherein rotation of the ring gear relative to the drive gear is a function of the flow volume of fluid passing through the flow controller.

14. A variable delivery gear pump as set forth in claim 11, further comprising a plurality of planet gears, each planet gear engaging the drive gear and the ring gear and forming a respective external gear pump and a respective internal gear pump.

15. A variable delivery gear pump as set forth in claim 14, further comprising a carrier on which the plurality of planet gears are mounted.

16. A variable delivery gear pump as set forth in claim 14, further comprising a spacer member positioned between respective planet gears, the spacer member providing a tip seal for at least one of the adjacent planet gears, the drive gear, and the ring gear.

17. A gear pump comprising an external gear pump formed by at least two sprockets, and an internal gear pump formed by one of the at least two sprockets and a ring gear, wherein the external gear pump and internal gear pump are positioned within a housing.
